(19) United States
(12) Patent Application Publication
(10) Pub. No.: US 2011/0123241 A1
(43) Pub. Date: May 26, 2011

(54) DISCHARGE DEVICE OF IMAGE FORMING APPARATUS, IMAGE FORMING APPARATUS HAVING THE SAME AND CONTROL METHOD THEREOF

(75) Inventors: HYUN HO KIM, SEOUL (KR); YOUNG SOO KO, SUWON-SI (KR)

(73) Assignee: SAMSUNG ELECTRONICS CO., LTD., SUWON-SI (KR)

(21) Appl. No.: 12/912,138

(22) Filed: Oct. 26, 2010

(30) Foreign Application Priority Data
Nov. 25, 2009 (KR) 10-2009-114473

(51) Int. Cl. G03G 15/00

(52) U.S. Cl. 399/405

(57) ABSTRACT

Disclosed herein are a discharge device of an image forming apparatus, an image forming apparatus having the same, and a control method thereof, which prevents jamming or loading defects of paper to be discharged. To this end, a press force adjusting device is provided to adjust a press position of an elastic press member upward or downward. The press force adjusting device includes a press plate to support the elastic press member and a height adjustor to adjust a height of the press plate. The height adjustor adjusts the height of the press plate via rotation of a cam body having an eccentric rotation center. The height adjustment enables adjustment in the curling degree of paper depending on a paper thickness or environment conditions.

### CROSS-REFERENCE TO RELATED APPLICATIONS

This application claims the benefit of Korean Patent Application No. 10-2009-0114473, filed on Nov. 25, 2009 in the Korean Intellectual Property Office, the disclosure of which is incorporated herein by reference.

### BACKGROUND

1. Field

Embodiments relate to a discharge device of an image forming apparatus, which may restrict curling of paper to be discharged, an image forming apparatus having the same and a control method thereof.

2. Description of the Related Art

Generally, image forming apparatuses are devised to form an image on a printing medium according to input signals. Examples of image forming apparatuses include printers, copiers, fax machines, and devices combining functions thereof.

In an image forming apparatus, after light is irradiated to a photoconductor, which has been charged with a predetermined electric potential, to form an electrostatic latent image on a surface of the photoconductor, toner, i.e. developer is fed to the electrostatic latent image to form a visible toner image. The toner image, formed on the photoconductor, is directly transferred to paper, or is indirectly transferred to the paper by way of an intermediate transfer member. The image transferred to the paper is fixed to the paper via a fusing process. Thereafter, the paper is discharged to the outside by a discharge device.

In the above described operation, the paper to be discharged may curl due to, e.g., fusing heat. Therefore, in addition to a discharge roller, the discharge device includes a de-curling roller to restrict curling of the paper. The de-curling roller is rotated in contact with the discharge roller, thus restricting forward curling of the paper to be discharged.

However, the de-curling roller has been conventionally designed to apply only constant pressure to the discharge roller and therefore, the paper to be discharged may undergo uneven curling depending on a paper thickness or environmental conditions. This may cause paper jamming or loading defects.

### SUMMARY

Additional aspects and/or advantages will be set forth in part in the description which follows and, in part, will be apparent from the description, or may be learned by practice of the invention.

Therefore, it is an aspect to provide a discharge device of an image forming apparatus which may prevent jamming or loading defects of paper to be discharged, an image forming apparatus having the same, and a control method thereof.

It is another aspect to provide a discharge device of an image forming apparatus which may adjust a curling degree of paper depending on a paper thickness or environmental conditions, an image forming apparatus having the same and a control method thereof.

Additional aspects will be set forth in part in the description which follows and, in part, will be obvious from the description, or may be learned by practice of the invention.

In accordance with one aspect, an image forming apparatus includes a body, and a discharge device to discharge paper out of the body, wherein the discharge device includes a first discharge roller that is rotatable, a second discharge roller that is rotated in contact with the first discharge roller to discharge the paper, an elastic press member to press at least one of the first discharge roller and the second discharge roller, and a press force adjusting device to change a press position of the elastic press member.

The elastic press member may be arranged below the second discharge roller, and the press force adjusting device may include a press plate to support the elastic press member and a height adjustor to adjust a height of the press plate.

The height adjustor may include a cam body having an eccentric rotation center, and a plurality of plate contact portions formed at an outer surface of the cam body at different distances from the rotation center so that a selected one of the plate contact portions supports the press plate.

The selected one of the plurality of plate contact portions to support the press plate may be determined according to rotation of the cam body.

The plurality of plate contact portions may include a first plate contact portion spaced apart from the rotation center by a first distance, a second plate contact portion spaced apart from the rotation center by a second distance shorter than the first distance, and a third plate contact portion spaced apart from the rotation center by a third distance longer than the first distance.

The image forming apparatus may further include a temperature and humidity sensing device to sense a temperature and/or humidity of the surroundings, the first plate contact portion may support the press plate if the temperature and/or humidity measured by the temperature and/or humidity sensing device fall in a first temperature/humidity condition corresponding to a general temperature/humidity condition, the second plate contact portion may support the press plate if the temperature and/or humidity measured by the temperature and humidity sensing device fall in a second temperature/humidity condition corresponding to a high-temperature and high-humidity condition, and the third plate contact portion may support the press plate if the temperature and/or humidity measured by the temperature and/or humidity sensing device fall in a third temperature/humidity condition corresponding to a low-temperature and low-humidity condition.

The image forming apparatus may further include a paper sensing device to measure a thickness of the paper, the first plate contact portion may support the press plate if the paper thickness measured by the paper sensing device is a first thickness corresponding to a general paper thickness, the second plate contact portion may support the press plate if the paper thickness measured by the paper sensing device is a second thickness corresponding to a thin paper thickness, and the third plate contact portion may support the press plate if the paper thickness measured by the paper sensing device is a third thickness corresponding to a thick paper thickness.

The first plate contact portion may be perpendicular to the second plate contact portion and the third plate contact portion on the basis of the rotation center, and the second plate contact portion and the third plate contact portion may be parallel to each other.

The cam body may have a square cross section.

The cam body may have an elliptical cross section.

A lever may extend from one side of the cam body to allow a user to apply drive power to the cam body.

The cam body may be rotated by a drive motor.

In accordance with another aspect, a discharge device of an image forming apparatus to discharge paper out of the image forming apparatus, includes a first discharge roller that is rotatable, a second discharge roller that is rotated in contact with the first discharge roller to discharge the paper, an elastic press member to press at least one of the first discharge roller and the second discharge roller, and a de-curling adjusting device to adjust a de-curling degree of the paper by changing a press position of the elastic press member depending on a curling degree of the paper.

The elastic press member may be arranged below the second discharge roller, and the de-curling adjusting device may include a press plate to support the elastic press member and a height adjustor to adjust a height of the press plate.

The height adjustor may include a cam body having an eccentric rotation center, and a plurality of plate contact portions formed at an outer surface of the cam body at different distances from the rotation center so that a selected one of the plate contact portions supports the press plate.

In a further aspect, in a control method of an image forming apparatus, the image forming apparatus includes a body and a discharge device to discharge paper out of the body, the discharge device includes a first discharge roller that is rotatable, a second discharge roller that is rotated while being engaged with the first discharge roller to discharge the paper, an elastic press member arranged below the second discharge roller to press the second discharge roller toward the first discharge roller, a press plate to support the elastic press member, and a height adjustor to adjust a height of the press plate, the height adjustor realizes a relatively low height of the press plate if the paper is thin or under a high-temperature and/or high-humidity condition and also, realizes a relatively high height of the press plate if the paper is thick or under a low-temperature and/or low-humidity condition.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a view illustrating an interior configuration of an image forming apparatus according to an embodiment;

FIG. 2 is a perspective view of a discharge roller unit included in a discharge device;

FIG. 3 is a side view of the discharge roller unit;

FIG. 4A is a side view of the discharge roller unit under the condition of a general paper thickness and normal environmental conditions;

FIG. 4B is a perspective view of FIG. 4A;

FIG. 5A is a side view of the discharge roller unit under the condition of a thin paper thickness and high-temperature and high-humidity environmental conditions;

FIG. 5B is a perspective view of FIG. 5A;

FIG. 6A is a side view of the discharge roller unit under the condition of a thick paper thickness and low-temperature and low-humidity environmental conditions;

FIG. 6B is a perspective view of FIG. 6A;

FIG. 7 is a flow chart illustrating a control method of the image forming apparatus depending on environmental conditions;

FIG. 8 is a flow chart illustrating a control method of the image forming apparatus depending on a paper thickness; and

FIG. 9 is a side view illustrating a discharge roller unit of the image forming apparatus according to another embodiment.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

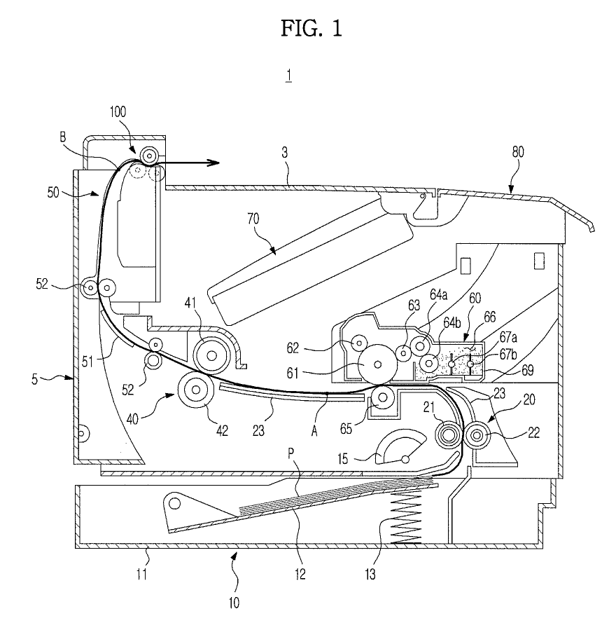

FIG. 1 is a view illustrating an interior configuration of an image forming apparatus according to an embodiment.

As illustrated in FIG. 1, the image forming apparatus 1 includes a body 5, a paper supply device 10 in which paper P is loaded, a feeding device 20 to feed the paper P, a developing device 60 to form an image on the paper P, a fusing device 40 to fuse the image to the paper P, a discharge device 50 to discharge the paper P, and a cover 80 to be opened away from or closed to an upper front portion of the body 5.

The paper supply device 10 serves to supply the paper P and is installed below the body 5. The paper supply device 10 includes a paper supply tray 11 in the form of a cassette, and a press plate 12 and a press spring 13 to push the paper P inside the paper supply tray 11 upward to a pickup roller 15. The press spring 13 is installed below the press plate 12, to push the press plate 12 toward the pickup roller 15. The pickup roller 15 picks up the paper P sheet by sheet via rotation thereof, to supply the paper P to the feeding device 20.

The feeding device 20 feeds the paper P picked up by the pickup roller 15 in a print path A. The feeding device 20 includes a feeding roller 21, a feeding backup roller 22, and a feeding guide 23 to define the print path A.

The developing device 60 is detachably mounted in the body 5. The developing device 60 includes a photoconductor 61 located on the print path A, on a surface of which an electrostatic latent image is formed, a charge roller 62 to charge the photoconductor 61, a developing roller 63 to form a visible image by supplying developer to the electrostatic latent image formed on the photoconductor 61, supply rollers 64a and 64b to supply the developer to the developing roller 63, a developer reservoir 66 in which the developer is received, developer agitators 67a and 67b installed inside the developer reservoir 66 to agitate the developer, and a housing 69 defining an exterior appearance of the developing device 60.

In the meantime, a transfer roller 65, which is given as a transfer device by way of example, is arranged on the print path A to transfer the image from the photoconductor 61 to the paper P.

A Laser Scanning Unit (LSU) 70 is provided in the body 5 to form the electrostatic latent image by irradiating a laser beam containing image information to the photoconductor 61 that has been charged.

The charge roller 62 charges the photoconductor 61, and the LSU 70 irradiates a laser beam to the photoconductor 61 thus causing an electrostatic latent image to be formed on the surface of the photoconductor 61. The developing roller 63 attaches the developer to the electrostatic latent image of the photoconductor 61 thus forming a developer image. The transfer roller 65 transfers the developer attached to the photoconductor 61 to the paper P.

The fusing device 40 includes a heating roller 41 and a press roller 42. The fusing device 40 applies heat and pressure to the developer image transferred to the paper P passing between the heating roller 41 and the press roller 42, allowing the developer image to be fused to the paper P.

The discharge device 50 feeds the paper P having passed through the fusing device 40 to a loading part 3 defined at the top of the body 5. The discharge device 50 includes discharge guides 51 to guide the paper P to the loading part 3, a plurality of discharge rollers 52 arranged on a discharge path B, and a discharge roller unit 100 to discharge the paper P to the loading part 3.

Hereinafter, the discharge roller unit 100 of the discharge device 50 will be described in detail with reference to the accompanying drawings.

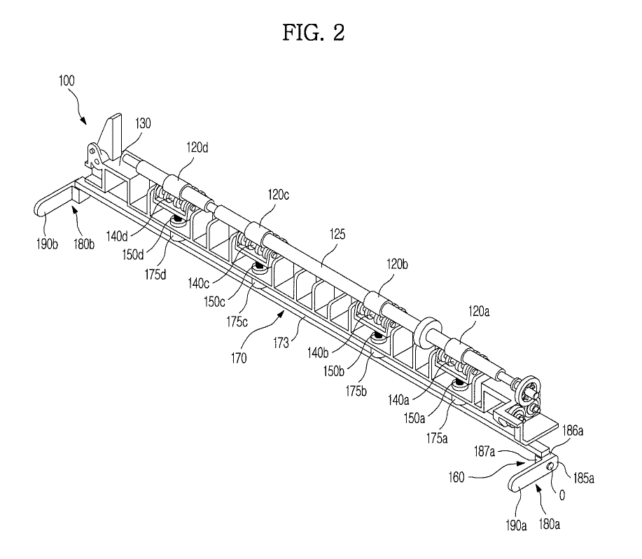

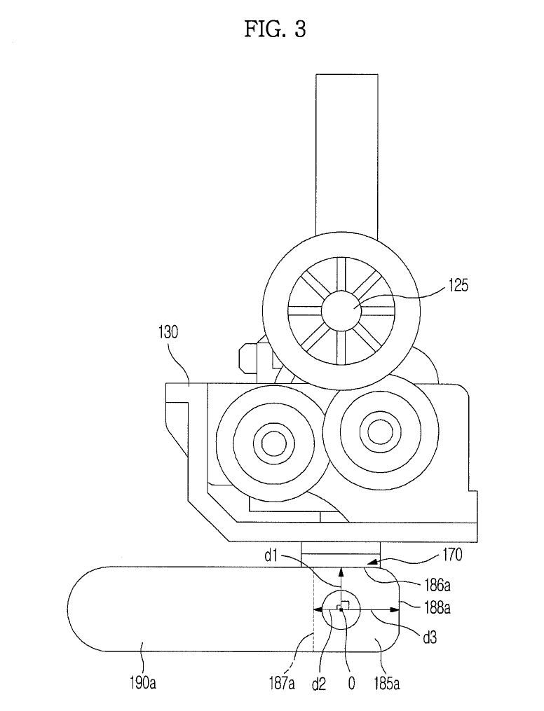

FIG. 2 is a perspective view of the discharge roller unit included in the discharge device, and FIG. 3 is a side view of the discharge roller unit.

As illustrated in FIGS. 2 and 3, the discharge roller unit 100 of the discharge device 50 includes a roller unit frame 130, first discharge rollers 120a, 120b, 120c and 120d that are rotatable, and second discharge rollers 140a, 140b, 140c and 140d that are rotated in contact with the first discharge rollers 120a, 120b, 120c and 120d to discharge the paper P.

The first discharge rollers 120a, 120b, 120c and 120d are rotatably fitted on a first discharge roller shaft 125. The plurality of first discharge rollers 120a, 120b, 120c and 120d is arranged in an axial direction of the first discharge roller shaft 125. The first discharge roller shaft 125 is connected to a motor (not shown) so as to be rotated by the motor. The first discharge rollers 120a, 120b, 120c and 120d are also rotated along with the first discharge roller shaft 125.

The second discharge rollers 140a, 140b, 140c and 140d are rotated by contact force with the first discharge rollers 120a, 120b, 120c and 120d. The paper P to be discharged passes between the second discharge rollers 140a, 140b, 140c and 140d and the first discharge rollers 120a, 120b, 120c and 120d.

The second discharge rollers 140a, 140b, 140c and 140d are a combination of a plurality of rollers. The plurality of second discharge rollers 140a, 140b, 140c and 140d is installed to the roller unit frame 130 to correspond to the respective first discharge rollers 120a, 120b, 120c and 120d. The second discharge rollers 140a, 140b, 140c and 140d serve as de-curling rollers to restrict forward curling of the paper P due to, e.g., fusing heat.

Elastic press members 150a, 150b, 150c and 150d are arranged below the second discharge rollers 140a, 140b, 140c and 140d to press the second discharge rollers 140a, 140b, 140c and 140d.

Each of the plurality of elastic press members 150a, 150b, 150c and 150d is arranged below respective ones of the second discharge rollers 140a, 140b, 140c and 140d. In an embodiment, springs are used as the elastic press members.

A press force adjusting device 160 is provided to change press positions of the elastic press members 150a, 150b, 150c and 150d. The press force adjusting device 160 includes a press plate 170 to support the elastic press members 150a, 150b, 150c and 150d from the underside thereof, and height adjustors 180a and 180b to adjust a height of the press plate 170. The press force adjusting device 160 serves as a de-curling adjusting device to adjust de-curling of the paper P by changing press positions of the elastic press members 150a, 150b, 150c and 150d.

The press plate 170 supports the elastic press members 150a, 150b, 150c and 150d from the underside thereof, and serves to change press positions of the elastic press members 150a, 150b, 150c and 150d according to the height adjustment operation of the height adjustors 180a and 180b.

The press plate 170 includes a plate portion 173 disposed along the roller unit frame 130, and supporting protrusions 175a, 175b, 175c and 175d protruding from the plate portion 173 at positions corresponding to the respective elastic press members 150a, 150b, 150c and 150d. The supporting protrusions 175a, 175b, 175c and 175d penetrate through the roller unit frame 130 to support the elastic press members 150a, 150b, 150c and 150d.

The height adjustors 180a and 180b are provided at both ends of the press plate 170. Both the left and right height adjustors 180a and 180b are symmetrical to each other and thus, the following description is concentrated on the right height adjustor 180a.

The height adjustor 180a includes a cam body 185a having an eccentric rotation center O, and a plurality of plate contact portions 186a, 187a and 188a formed at an outer surface of the cam body 185a so that any one of the plate contact portions 186a, 187a and 188a supports the press plate 170. Specifically, of the plurality of plate contact portion 186a, 187a and 188a, only one of the plate contact portion 186a, 187a or 188a is selected to support the press plate 170 according to rotation of the cam body 185a.

A lever 190a extends from one side of the cam body 185a to allow a user to apply drive power to the cam body 185a so as to rotate the cam body 185a.

If the user rotates the lever 190a in consideration of a thickness of the paper P to be discharged or environmental conditions, the cam body 185a connected to the lever 190a is rotated, causing the height of the press plate 170 to be changed and thus, causing the elastic press members 150a, 150b, 150c and 150d to press the second discharge rollers 140a, 140b, 140c and 140d at upwardly or downwardly changed positions.

In an embodiment, the cam body 185a has a squre cross section.

The respective plate contact portions 186a, 187a and 188a are located at different distances from the rotation center O. The plate contact portions 186a, 187a and 188a include a first plate contact portion 186a spaced apart from the rotation center O by a predetermined first distance d1, a second plate contact portion 187a spaced apart from the rotation center O by a predetermined second distance d2 shorter than the first distance d1, and a third plate contact portion 188a spaced apart from the rotation center O by a predetermined third distance d3 longer than the first distance d1.

The first plate contact portion 186a is perpendicular to the second plate contact portion 187a and the third plate contact portion 188a on the basis of the rotation center O, and the second plate contact portion 187a and the third plate contact portion 188a are parallel to each other.

Hereinafter, operation of the discharge roller unit 100 of the discharge device 50 according to an embodiment will be described.

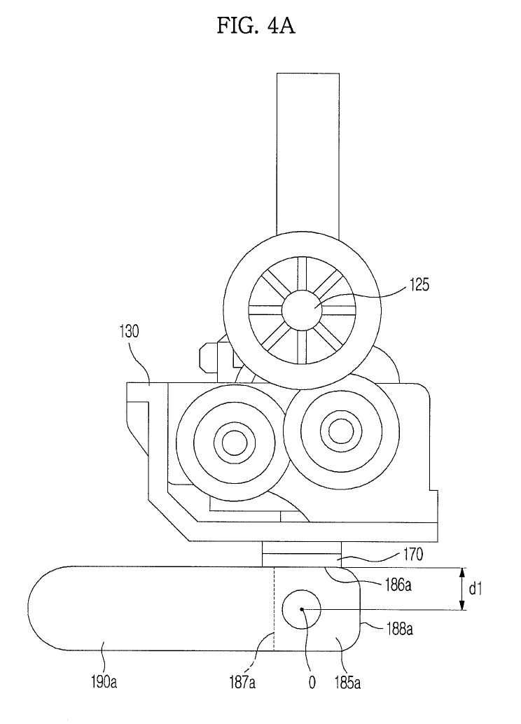

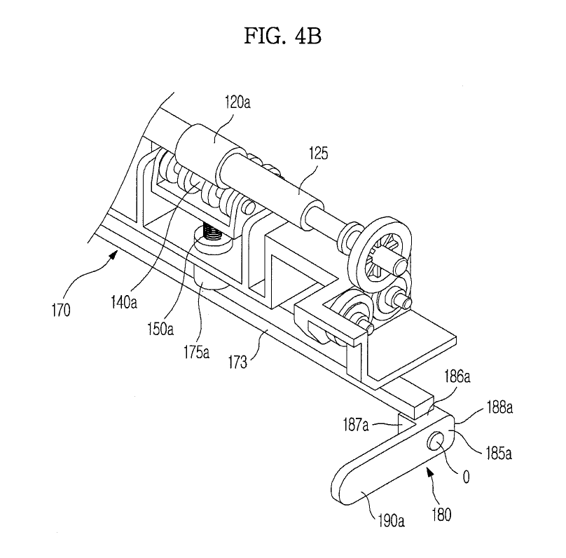

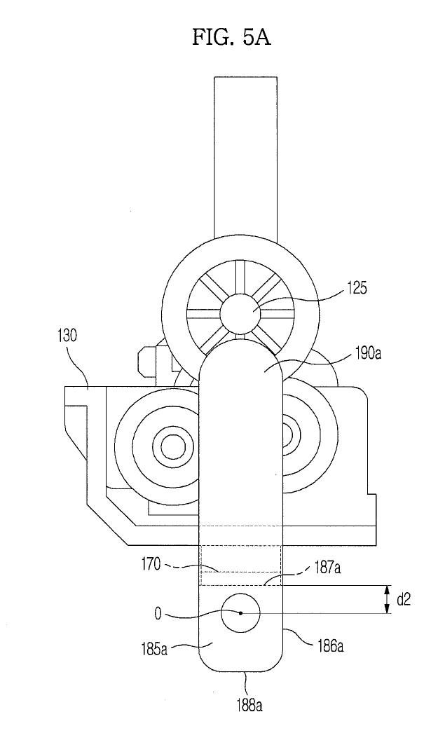

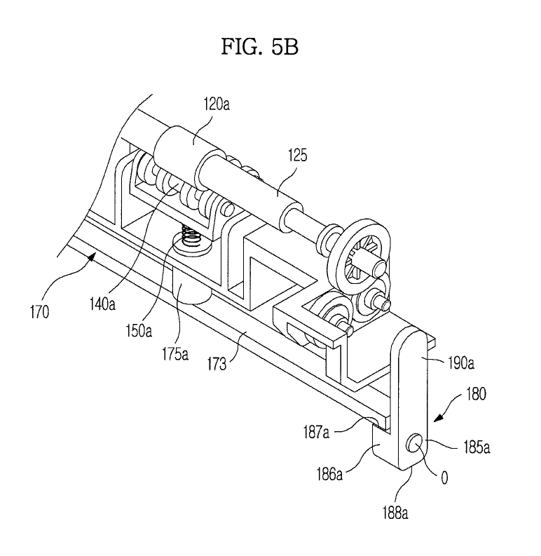

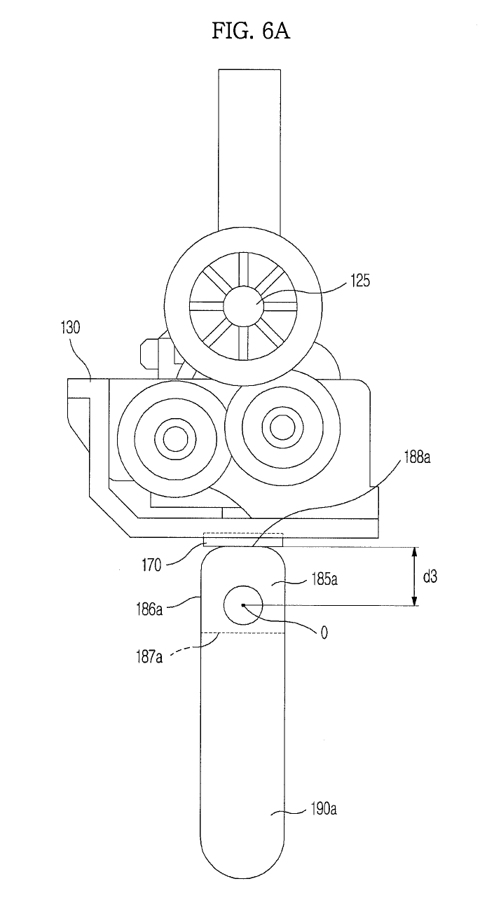

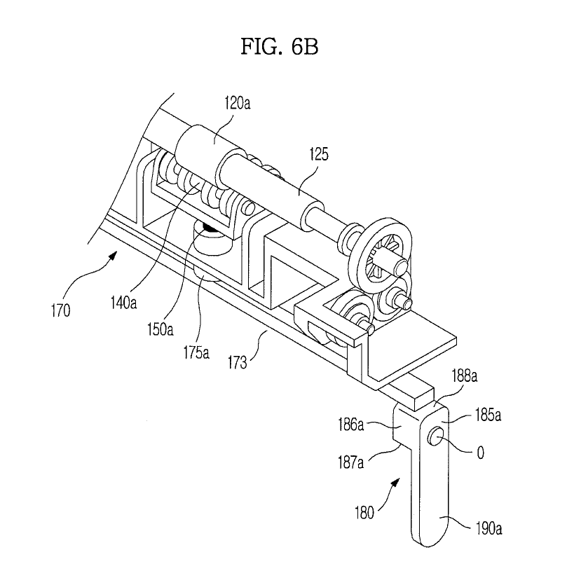

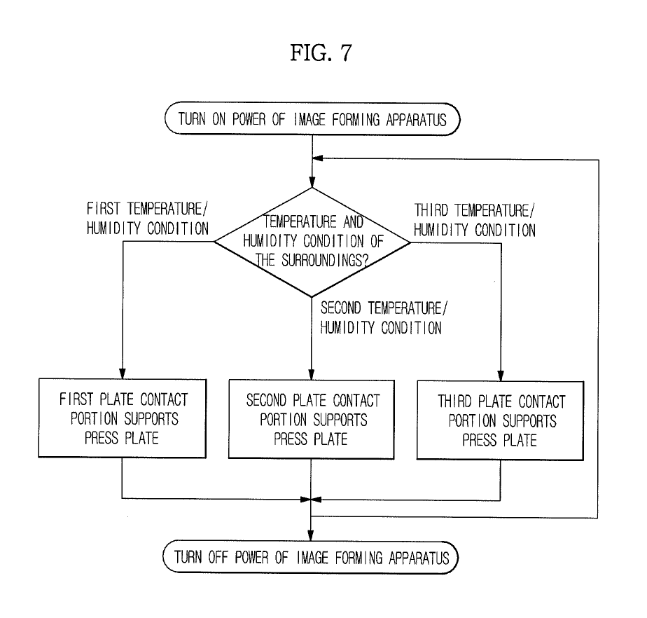

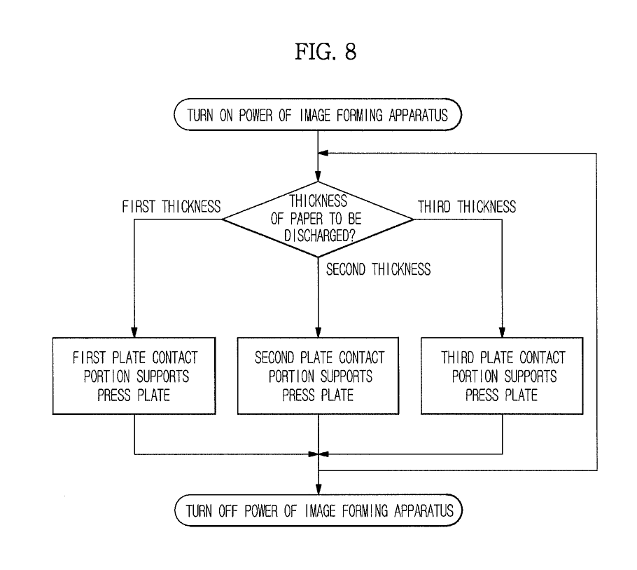

FIG. 4A is a side view of the discharge roller unit under the condition of a general paper thickness and normal environmental conditions, and FIG. 4B is a perspective view of FIG. 4A. FIG. 5A is a side view of the discharge roller unit under the condition of a thin paper thickness and high-temperature and high-humidity environmental conditions, and FIG. 5B is a perspective view of FIG. 5A. FIG. 6A is a side view of the discharge roller unit under the condition of a thick paper thickness and low-temperature and low-humidity environmental conditions, and FIG. 6B is a perspective view of FIG. 6A. FIG. 7 is a flow chart illustrating a control method of the image forming apparatus depending on environmental conditions, and FIG. 8 is a flow chart illustrating a control method of the image forming apparatus depending on a paper thickness.

When power of the image forming apparatus 1 is turned on, the paper having passed through the fusing device 40 is discharged onto the loading part 3 by the discharge roller unit 100 of the discharge device 50. In this case, the paper P to be discharged may experience different degrees of curling due to, e.g., fusing heat depending on a thickness of the paper P or environmental conditions. Specifically, the paper P may experience a reduced forward curling degree if the paper P is thin or under a high-temperature and high-humidity condition. On the other hand, the paper P may experience an increased forward curling degree if the paper P is thick or under a low-temperature and low-humidity condition.

Accordingly, the image forming apparatus 1 according to an embodiment attempts to adjust the curling degree of paper by upwardly or downwardly changing press positions where the elastic press members 150a, 150b, 150c and 150d press the second discharge rollers 140a, 140b, 140c and 140d. In this case, the second discharge rollers 140a, 140b, 140c and 140d act as de-curling rollers to restrict forward curling of paper. These rollers will be described in detail hereinafter.

As illustrated in FIGS. 4A and 4B, in the case where the paper P to be discharged has a thickness, the paper P undergoes levels of curling. In this case, the press plate 170 is supported by the first plate contact portion 186a at a position higher than the rotation center O of the cam body 185a by the first distance d1. Thereby, the elastic press members 150a, 150b, 150c and 150d supported by the supporting protrusions 175a, 175b, 175c and 175d of the press plate 170 press the second discharge rollers 140a, 140b, 140c and 140d by press force corresponding to the height of the press plate 170.

However, if the paper P is thin or is under a high-temperature and high-humidity condition, the curling degree of the paper P is lowered. In this case, as illustrated in FIGS. 5A and 5B, the user rotates the lever 190a upward to allow the second plate contact portion 187a to support the press plate 170 at a position higher than the rotation center O of the cam body 185a by the second distance d2. That is, in consideration of the relatively low curling degree of the paper P, supporting positions of the elastic press members 150a, 150b, 150c and 150d are lowered to allow the elastic press members 150a, 150b, 150c and 150d to press the second discharge rollers 140a, 140b, 140c and 140d with a reduced press force.

On the contrary, if the paper P is thick or is under a low-temperature and low-humidity condition, the curling degree of the paper P is increased. In this case, as illustrated in FIGS. 6A and 6B, the user rotates the lever 190a downward to allow the third plate contact portion 188a to support the press plate 170 at a position higher than the rotation center O of the cam body 185a by the third distance d3. That is, in consideration of the relatively high curling degree of the paper P, supporting positions of the elastic press members 150a, 150b, 150c and 150d are raised to allow the elastic press members 150a, 150b, 150c and 150d to press the second discharge rollers 140a, 140b, 140c and 140d with an increased press force.

Although the user directly rotates the lever 190a in the above described embodiment, a separate drive motor (not shown) may be connected to the rotation center O to rotate the cam body 185a inside the discharge device 50.

Alternatively, a paper sensing device (not shown) to measure a paper thickness may be provided inside the body 5. Signals from the paper sensing device may be transmitted to a controller (not shown), so that the drive motor connected to the cam body 185a may be operated by the controller.

Alternatively, a temperature and humidity sensing device (not shown) to sense a temperature and humidity around the paper P may be provided inside the body 5. Signals from the temperature and humidity sensing device may be transmitted to the controller, so that the drive motor connected to the cam body 185a may be operated by the controller.

As illustrated in FIG. 7, considering a control method of the image forming apparatus 1 depending on a thickness of the paper P, the paper sensing device measures the paper thickness in a power-On state of the image forming apparatus 1 and transmits measured signals to the controller.

In the case where the measured thickness of the paper P is a first thickness that corresponds to a general paper thickness, the controller transmits a signal to the drive motor to allow the first plate contact portion 186a to support the press plate 170. In the case where the measured thickness of the paper P is a second thickness that corresponds to a relatively thin paper thickness, the controller transmits a signal to the drive motor to allow the second plate contact portion 187a to support the press plate 170. Also, in the case where the measured thickness of the paper P is a third thickness that corresponds to a relatively thick paper thickness, the controller transmits a signal to the drive motor to allow the third plate contact portion 188a to support the press plate 170.

As illustrated in FIG. 8, in a control method of the image forming apparatus 1 according to environmental conditions, the temperature and humidity sensing device senses a temperature and humidity of the surroundings in a power-On state of the image forming apparatus 1 and transmits measured signals to the controller.

In the case where the measured temperature and humidity fall in a first temperature/humidity condition that corresponds to a general temperature and humidity, the controller transmits a signal to the drive motor to allow the first plate contact portion 186a to support the press plate 170. In the case where the measured temperature and humidity fall in a second temperature/humidity condition that corresponds to a relatively high temperature and humidity, the controller transmits a signal to the drive motor to allow the second plate contact portion 187a to support the press plate 170. Also, in the case where the measured temperature and humidity fall in a third temperature/humidity conditioner that corresponds to a relatively low temperature and humidity, the controller transmits a signal to the drive motor to allow the third plate contact portion 188a to support the press plate 170.

Hereinafter, another embodiment will be described, although the same configurations as those of the above described embodiment will not be described.

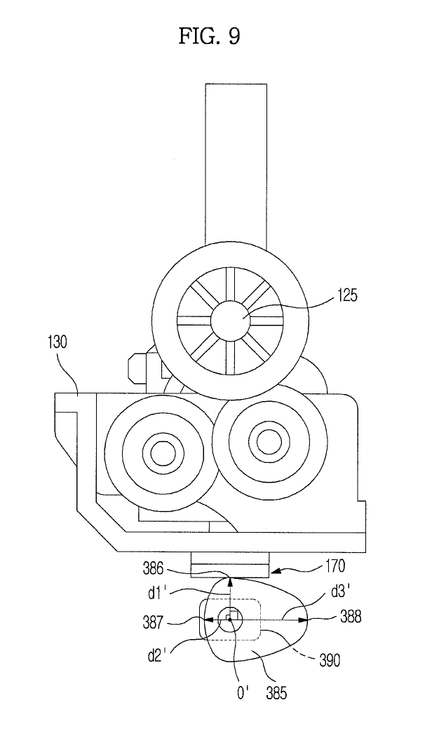

FIG. 9 is a side view illustrating a discharge roller unit of the image forming apparatus according to another embodiment.

A discharge roller unit according to the present embodiment includes a cam body 385 having an elliptical cross section. A rotation center O′ of the cam body 385 is connected to a drive motor 390 and is rotated by drive power of the drive motor 390.

With use of the elliptical cam body 385, the press plate 170 shows a reduced upward/downward movement distance during rotation of the cam body 385 and thus, may achieve smooth adjustment of a press position.

Other configurations, including distances d1′, d2′ and d3′ from the rotation center O′ to the plurality of plate contact portions 386, 387 and 388, are equal to the above described embodiment and thus, a control method thereof is equal to the above described embodiment.

The above described image forming apparatus 1 may reduce jamming or loading defects of the paper P to be discharged, and may assure increased user satisfaction related to the printing results of the discharged paper P.

As apparent from the above description, an embodiment provides a discharge device of an image forming apparatus, an image forming apparatus having the same and a control method thereof, in which an elastic press member used to press a paper discharge roller has a variable press position, enabling adjustment in the curling degree of paper to be discharged.

Further, the curling degree of paper may be adjusted depending on a paper thickness or environmental conditions. This may prevent paper jamming or loading defects.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An image forming apparatus comprising:
a body; and
a discharge device to discharge paper out of the body,
wherein the discharge device comprises:
a first discharge roller that is rotatable;
a second discharge roller that is rotated in contact with the first discharge roller to discharge the paper;
an elastic press member to press at least one of the first discharge roller and the second discharge roller; and
a press force adjusting device to change a press position of the elastic press member.

2. The image forming apparatus according to claim 1, wherein:
the elastic press member is arranged below the second discharge roller; and
the press force adjusting device includes a press plate to support the elastic press member and a height adjustor to adjust a height of the press plate.

3. The image forming apparatus according to claim 2, wherein the height adjustor includes:
a cam body having an eccentric rotation center; and
a plurality of plate contact portions formed at an outer surface of the cam body at different distances from the rotation center so that a selected one of the plate contact portions supports the press plate.

4. The image forming apparatus according to claim 3, wherein the selected one of the plurality of plate contact portions to support the press plate is determined according to rotation of the cam body.

5. The image forming apparatus according to claim 3, wherein the plurality of plate contact portions includes:
a first plate contact portion spaced apart from the rotation center by a first distance;
a second plate contact portion spaced apart from the rotation center by a second distance shorter than the first distance; and
a third plate contact portion spaced apart from the rotation center by a third distance longer than the first distance.

6. The image forming apparatus according to claim 5, further comprising a temperature and humidity sensing device to sense a temperature and/or humidity of the surroundings,
wherein:
the first plate contact portion supports the press plate if the temperature and/or humidity measured by the temperature and/or humidity sensing device fall in a first temperature/humidity condition corresponding to a general temperature/humidity condition;
the second plate contact portion supports the press plate if the temperature and/or humidity measured by the temperature and/or humidity sensing device fall in a second temperature/humidity condition corresponding to a high-temperature and/or high-humidity condition; and
the third plate contact portion supports the press plate if the temperature and/or humidity measured by the temperature and/or humidity sensing device fall in a third temperature/humidity condition corresponding to a low-temperature and/or low-humidity condition.

7. The image forming apparatus according to claim 5, further comprising a paper sensing device to measure a thickness of the paper,
wherein:
the first plate contact portion supports the press plate if the paper thickness measured by the paper sensing device is a first thickness corresponding to a paper thickness;
the second plate contact portion supports the press plate if the paper thickness measured by the paper sensing device is a second thickness corresponding to a thin paper thickness; and
the third plate contact portion supports the press plate if the paper thickness measured by the paper sensing device is a third thickness corresponding to a thick paper thickness.

8. The image forming apparatus according to claim 5, wherein the first plate contact portion is perpendicular to the second plate contact portion and the third plate contact portion on the basis of the rotation center, and the second plate contact portion and the third plate contact portion are parallel to each other.

9. The image forming apparatus according to claim 3, wherein the cam body has a square cross section.

10. The image forming apparatus according to claim 3, wherein the cam body has an elliptical cross section.

11. The image forming apparatus according to claim 3, wherein a lever extends from one side of the cam body to allow a user to apply drive power to the cam body.

12. The image forming apparatus according to claim 3, wherein the cam body is rotated by a drive motor.

13. A discharge device of an image forming apparatus to discharge paper out of the image forming apparatus, the discharge device comprising:
a first discharge roller that is rotatable;
a second discharge roller that is rotated in contact with the first discharge roller to discharge the paper;
an elastic press member to press at least one of the first discharge roller and the second discharge roller; and
a de-curling adjusting device to adjust a de-curling degree of the paper by changing a press position of the elastic press member depending on a curling degree of the paper.

14. The discharge device according to claim 13, wherein:
the elastic press member is arranged below the second discharge roller; and
the de-curling adjusting device includes a press plate to support the elastic press member and a height adjustor to adjust a height of the press plate.

15. The discharge device according to claim 14, wherein the height adjustor includes:
a cam body having an eccentric rotation center; and
a plurality of plate contact portions formed at an outer surface of the cam body at different distances from the rotation center so that a selected one of the plate contact portions supports the press plate.

16. The discharge device according to claim 15, wherein the plurality of plate contact portions includes:
a first plate contact portion spaced apart from the rotation center by a first distance;
a second plate contact portion spaced apart from the rotation center by a second distance shorter than the first distance; and
a third plate contact portion spaced apart from the rotation center by a third distance longer than the first distance.

17. The discharge device according to claim 16, wherein the first plate contact portion is perpendicular to the second plate contact portion and the third plate contact portion on the basis of the rotation center, and the second plate contact portion and the third plate contact portion are parallel to each other.

18. The discharge device according to claim 15, wherein the cam body has a square cross section.

19. The discharge device according to claim 15, wherein a lever extends from one side of the cam body to allow a user to apply drive power to the cam body.

20. An image forming apparatus,
comprising a body; and
a discharge device to discharge paper out of the body,
the discharge device comprising;
a first discharge roller that is rotatable,
a second discharge roller that is rotated while being engaged with the first discharge roller to discharge the paper,
an elastic press member arranged below the second discharge roller to press the second discharge roller toward the first discharge roller,
a press plate to support the elastic press member, and a height adjustor to adjust a height of the press plate, the height adjustor realizes a relatively low height of the press plate if the paper is thin or under a high-temperature and high-humidity condition, and
the height adjustor realizes a relatively high height of the press plate if the paper is thick or under a low-temperature and low-humidity condition.

21. A method of adjusting a height of a press plate for an image forming apparatus, comprising:
detecting a temperature; and
adjusting the height of the press plate according to the temperature.

22. The method of claim 21, further comprising:
detecting a humidity; and
adjusting the height of the press plate according to the humidity.
